(19) United States
(12) Patent Application Publication
(10) Pub. No.: US 2021/0141911 A1
(43) Pub. Date: May 13, 2021

(54) COMMUNICATION DEVICE AND CONTROL METHOD

(71) Applicant: SONY SEMICONDUCTOR SOLUTIONS CORPORATION, KANAGAWA (JP)

(72) Inventor: TOSHIYUKI IIJIMA, KANAGAWA (JP)

(21) Appl. No.: 16/617,337

(22) PCT Filed: May 22, 2018
(86) PCT No.: PCT/JP2018/019579

§ 371 Date: Nov. 26, 2019

(30) Foreign Application Priority Data
Jun. 5, 2017 (JP) 2017-110609

(51) Int. Cl. G06F 21/62; H04W 4/38; H04W 4/029; G06F 21/60; G06Q 20/32

(52) U.S. Cl. CPC G06F 21/62; H04W 4/38; H04W 4/029; G06Q 20/3278; G06Q 20/326; G06Q 20/3224; G06F 21/606

(57) ABSTRACT

The present technology relates to a communication device and a control method capable of suppressing data falsification. The communication device includes: an application processing unit that performs application processing; a communication unit that performs data communication; and a data processing unit that exchanges, with the communication unit, communication data to be a communication object, in which the application processing unit is made unable to refer to the communication data. The present technology is applicable to, for example, a communication device that performs communication via a mobile communication network.

### TECHNICAL FIELD

The present technology relates to a communication device and a control method, and more particularly relates to a communication device and a control method capable of suppressing falsification of data.

### BACKGROUND ART

In recent years, great attention has been paid to applications using positional information (positional data) obtained by utilizing a global positioning system (GPS) along with widespread use of mobile devices such as smartphones and mobile phones (for example, see Patent Document 1). In this type of applications, various kinds of processing are performed by transmitting positional data obtained by utilizing the GPS to a server provided by a business operator via a communication network.

### CITATION LIST

### Patent Document

Patent Document 1: Japanese Patent Application Laid-Open No. 2015-118573

### SUMMARY OF THE INVENTION

### Problems to be Solved by the Invention

By the way, since positional data is processed in plain text in a mobile device described above, there is a possibility that data is falsified, and a technology to suppress falsification of data such as the positional data has been demanded.

The present technology is made in view of the above-described situation and directed to suppressing falsification of data.

### Solutions to Problems

A communication device according to an aspect of the present technology is a communication device that includes an application processing unit that performs application processing, a communication unit that performs data communication, and a data processing unit that exchanges, with the communication unit, communication data to be a communication object, in which the application processing unit is made unable to refer to the communication data.

A control method according to an aspect of the present technology is a control method for a communication device including an application processing unit that performs application processing, a communication unit that performs data communication, and a data processing unit that exchanges, with the communication unit, communication data to be a communication object, the control method including the communication device performing control so as to make the application processing unit unable to refer to the communication data.

In the communication device and the control method according to the aspects of the present technology, the application processing unit that performs the application processing is made unable to refer to the communication data exchanged between the data processing unit and the communication unit that performs data communication.

Note that the communication device according to the one aspect of the present technology may be an independent device or may be an internal block constituting one device.

Furthermore, the term “communication” may include, of course, wireless communication and wired communication, and may further include communication in which the wireless communication and the wired communication are mixed, in other words, the wireless communication is performed in one section and the wired communication is performed in another section. Moreover, communication from one device to another device may be performed by wired communication, and communication from another device to one device may be performed by wireless communication.

### Effects of the Invention

According to the aspects of the present technology, falsification of data can be suppressed.

Note that the effect recited herein is not necessarily limited and may be any one of those recited in the present disclosure.

### BRIEF DESCRIPTION OF DRAWINGS

FIG. 1 is a block diagram illustrating an exemplary configuration of a communication device.

FIG. 2 is a block diagram illustrating an exemplary configuration of a communication device according to a first embodiment.

FIG. 3 is a block diagram illustrating an exemplary configuration of a communication device according to a second embodiment.

FIG. 4 is a block diagram illustrating an exemplary configuration of a communication device according to a third embodiment.

FIG. 5 is a block diagram illustrating an exemplary configuration of a communication device according to a fourth embodiment.

FIG. 6 is a block diagram illustrating an exemplary configuration of a communication device according to a fifth embodiment.

FIG. 7 is a block diagram illustrating an exemplary configuration of a communication device according to a sixth embodiment.

FIG. 8 is a block diagram illustrating an exemplary configuration of a communication device according to a seventh embodiment.

FIG. 9 is a block diagram illustrating an exemplary configuration of a communication device according to an eighth embodiment.

FIG. 10 is a block diagram illustrating an exemplary configuration of a communication device according to a ninth embodiment.

### MODE FOR CARRYING OUT THE INVENTION

In the following, embodiments of the present technology will be described referring to the drawings. Note that a description will be provided in the following order.

1. System Configuration

2. First Embodiment: Positional Data Protected by Hardware-like Path (Mobile Communication Network)

3. Second Embodiment: Positional Data Protected by Hardware-like Path (Wireless LAN Communication Network)

4. Third Embodiment: Positional Data Protected by Hardware-like Path and Encryption (Encryption inside Communication Device)

5. Fourth Embodiment: Positional Data Protected by Hardware-like Path and Encryption (Encryption in Communication with Server)

6. Fifth Embodiment: Positional Data Protected By Encryption

7. Sixth Embodiment: Payment Data Protected by Hardware-like Path

8. Seventh Embodiment: Payment Data Protected by Hardware-like Path and Encryption

9. Eighth Embodiment: Detection Data Protected by Hardware-like Path

10. Ninth Embodiment: Detection Data Protected by Hardware-like Path and Encryption

11. Modified Examples

### 1. SYSTEM CONFIGURATION

FIG. 1 is a block diagram illustrating an exemplary configuration of a communication device.

A communication device 10 is constituted as a mobile device such as a smartphone, a mobile phone, or a tablet computer, for example. Note that the communication device 10 may be, for example, a wearable computer of a wristwatch type, a spectacle type, or the like, or an in-vehicle device installed in an automobile. In other words, the communication device 10 may include any device as far as a communication function is provided.

In FIG. 1, the communication device 10 includes a CPU 100, a flash memory unit 111, a DRAM 112, a SIM card unit 113, an input unit 114, a memory card unit 115, an antenna unit 116, an amplifier unit 117, a communication module unit 118, a wireless communication unit 119, a GPS unit 120, a payment support wireless communication unit 121, a sensor unit 122, an audio signal processing unit 123, an audio input/output unit 124, a controller unit 125, a touch panel unit 126, a camera image processing unit 127, a camera unit 128, a power supply control unit 129, and a battery unit 130.

The CPU 100 operates as a central processing unit in the communication device 10 for various kinds arithmetic processing, operation control for the respective units, and the like. Note that, the CPU 100 includes an application processor (APP) that performs application processing, an analog baseband (ABB) as a communication block unit, and a digital baseband (DBB) although details thereof will be described later.

The flash memory unit 111 is constituted as a flash memory that is a kind of a nonvolatile memory. The flash memory unit 111 reads and writes various kinds of data in accordance with control from the CPU 100.

The DRAM 112 is constituted as a dynamic random access memory (DRAM) that is a kind of a volatile memory. The DRAM 112 reads and writes various kinds of data in accordance with the control from the CPU 100.

The SIM card unit 113 includes an IC card that records information such as identification information to identify a subscriber of a communication service utilized by a mobile device such as a smartphone or a mobile phone. The information recorded in the SIM card unit 113 is read in accordance with the control from the CPU 100.

The input unit 114 includes, for example, buttons, a keyboard, and the like. When operation is received from a user, the input unit 114 supplies an operation signal thereof to the CPU 100.

The memory card unit 115 is constituted as a memory card that is a detachable card type auxiliary storage device. The memory card unit 115 reads and writes various kinds of data in accordance with the control from the CPU 100.

The antenna unit 116, the amplifier unit 117, and the communication module unit 118 transmit/receive communication data via a mobile communication network. Note that, in the following description, data transmitted by the communication module unit 118 and the like out of the communication data will be also referred to as transmission data, and data received by the communication module unit 118 and the like will be also referred to as reception data.

In the communication device 10, in a case where the transmission data is transmitted, the following processing is performed. In other words, the transmission data from the CPU 100 is processed by the communication module unit 118 in accordance with a cellular communication protocol, and the transmission data (transmission signal) obtained as a result thereof is amplified by the amplifier unit 117, and then transmitted via the antenna unit 116. This transmission data is received and processed by the server 200 or the like installed in a base station via the mobile communication network.

Furthermore, in a case where the reception data is received in the communication device 10, the following processing is performed. In other words, the reception data (received signal) received via the antenna unit 116 is processed by the communication module unit 118 in accordance with the cellular communication protocol after being amplified by the amplifier unit 117, and the reception data obtained as a result thereof is supplied to the CPU 100. This reception data is transmitted via the mobile communication network by the server 200 or the like installed in the base station.

For example, the cellular communication protocols such as long term evolution (LTE), LTE-Advanced (LTE-A), or 5th generation (5G) can be mounted in the communication module unit 118. Note that the LTE is not limited to frequency division duplex-LTE (FDD-LTE), and may be time division-LTE (TD-LTE). Moreover, cellular communication protocols such as wideband code division multiple access (W-CDMA) or global system for mobile communications (GSM (registered trademark)) may also be mounted.

The wireless communication unit 119 performs transmission/reception of communication data by utilizing wireless communication such as a wireless local area network (LAN) in accordance with the control from the CPU 100. For example, besides a wireless communication protocol such as the wireless LAN (also referred to as Wi-Fi (registered trademark)), a near field wireless communication protocol such as Bluetooth (registered trademark) can be mounted in the wireless communication unit 119.

The GPS unit 120 receives global positioning system (GPS) signals from several GPS satellites in the sky out of GPS satellites that are artificial satellites used in GPS, and calculates an own current position (for example, latitude and longitude). Positional information (positional data) thus obtained is supplied to the CPU 100.

The payment support wireless communication unit 121 performs transmission/reception of communication data by utilizing near field wireless communication such as near field communication (NFC) in accordance with the control from the CPU 100. In other words, the near field wireless communication protocol such as the NFC can be mounted in the payment support wireless communication unit 121, for example.

Here, for example, when the communication device 10 is brought close to a dedicated payment terminal by a user who purchases a product, communication data is transmitted/received by utilizing the near field wireless communication such as the NFC, and a so-called mobile payment (electronic payment) with electronic money or the like is performed.

The sensor unit 122 performs sensing in accordance with the control from the CPU 100, and outputs detection data in accordance with a sensing result.

For example, the sensor unit 122 can include various kinds of sensors such as a magnetic sensor that detects magnitude and a direction of a magnetizing field (magnetic field), an acceleration sensor that detects acceleration, a gyro sensor that detects an angle (attitude), an angular velocity, and angular acceleration, an ambient light sensor that detects brightness in a periphery, a proximity sensor that detects a proximate object, or a biosensor that detects biological information such as a fingerprint, an iris, and a pulse.

Processing associated with audio is performed by the audio signal processing unit 123 and the audio input/output unit 124.

For example, the audio input/output unit 124 can include a speaker, a headphone, a microphone, and the like. The audio signal processing unit 123 processes audio data from the CPU 100 and outputs, from the audio input/output unit 124 such as the speaker or the headphone, a sound corresponding to an audio signal obtained as a result thereof. Furthermore, the audio signal processing unit 123 processes the audio signal that has been converted from a sound by the audio input/output unit 124 such as the microphone, and supplies the CPU 100 with audio data obtained as a result thereof.

Processing associated with display and operation is performed by the controller unit 125 and the touch panel unit 126.

For example, the touch panel unit 126 includes a touch panel in which a touch sensor and a display unit are integrated, and when operation is performed on the touch panel with a user's finger or a touch pen (stylus pen), the operation is detected by the touch sensor and an operation signal thereof is supplied to the CPU 100 via the controller unit 125.

In the touch panel unit 126, the display unit is constituted as a liquid crystal display, an organic EL display, or the like, for example. The controller unit 125 processes video data from the CPU 100 and displays, on the display unit such as the liquid crystal display, a video in accordance with a video signal obtained as a result thereof. Note that display information displayed on the display unit is not limited to the video, and includes various kinds of information such as text and an image.

The camera image processing unit 127 and the camera unit 128 perform processing associated with image capturing of a subject.

The camera unit 128 includes, for example, an image sensor such as a complementary metal oxide semiconductor (CMOS) image sensor or a charge coupled device (CCD) image sensor. The camera unit 128 supplies the camera image processing unit 127 with an imaging signal obtained by capturing an image of the subject with the image sensor.

The camera image processing unit 127 is constituted as, for example, a camera image signal processor (ISP). For example, in the camera image processing unit 127, not only, for example, correction processing in an optical system such as a lens and correction processing to handle variations in image sensors but also processing associated with exposure, focusing, white balance, and the like are applied to the imaging signal from the camera unit 128. Imaging data obtained as a result of the processing is supplied to the CPU 100.

Power is supplied to the respective units of the communication device 10 by the power supply control unit 129 and the battery unit 130.

For example, the battery unit 130 includes a secondary battery such as a lithium ion battery. Furthermore, for example, the power supply control unit 129 is constituted as a power management IC (PMIC). The power supply control unit 129 performs power supply control for the battery unit 130 including the secondary battery such as the lithium ion battery so as to appropriately supply the power to the respective units of the communication device 10.

The communication device 10 has the configuration as described above.

In the communication device 10, data supplied from the respective units is processed by the CPU 100. For example, the positional data from the GPS unit 120 and the detection data from the sensor unit 122 are processed by the CPU 100 in the communication device 10.

Here, the positional data from the GPS unit 120 includes text in an NMEA format. Therefore, the CPU 100 can display, on (a screen of a display unit of) the touch panel unit 126, display information in accordance with the positional data via the controller unit 125.

More specifically, in the CPU 100, the positional data from the GPS unit 120 is processed as display data by the application processor (APP), thereby displaying the display information on (the screen of the display unit of) the touch panel unit 126.

In FIG. 1, the positional data is encrypted by using an encryption key Ke1 by the GPS unit 120, and encrypted positional data obtained as a result thereof is supplied to the CPU 100. In the CPU 100, the encrypted positional data is decrypted by using a decryption key Kd1, and plain text PT1 of the positional data obtained as a result thereof is processed as the display data. As a result, positional information is displayed on the touch panel unit 126.

On the other hand, in a case of transmitting positional data as communication data via the mobile communication network, positional data same as the one used as the display information is processed by the digital baseband (DBB) or the analog baseband (ABB) in the CPU 100, and supplied to the communication module unit 118.

In FIG. 1, the plain text PT1 of the positional data used as the display information is encrypted by using an encryption key Ke2 in the CPU 100, and the encrypted positional data obtained by the encryption is supplied to the communication module unit 118. In the communication module unit 118, the encrypted positional data is decrypted by using a decryption key Kd2, and positional data obtained as a result thereof is transmitted.

With this procedure, the positional data is transmitted as the communication data (transmission data) to the server 200 by the communication module unit 118 via the mobile communication network.

Furthermore, the detection data from the sensor unit 122 is plain text, for example. This detection data is also transmitted as the communication data (transmission data) to the server 200 via the mobile communication network in a manner similar to the above-described positional data, and the detection data is further processed as display data so as to display detection information on the touch panel unit 126.

Moreover, for example, in a case of receiving payment data or the like transmitted as the communication data (reception data) from the server 200 via the mobile communication network also, payment information is displayed on the touch panel unit 126 by processing payment data as the communication data and also processing the payment data as the display data in the similar manner.

Note that, in a case of, for example, communication via a wireless LAN communication network or the like also, the positional data or the detection data same as those displayed as the display information is packetized by the application processor (APP), and transmitted to a server (not illustrated) by the wireless communication unit 119 via the wireless LAN communication network in the similar manner.

Thus, in the communication device 10, since various kinds of data such as the positional data, the detection data, and the payment data can be processed not only as the display data but also as the communication data by the application processor (APP) in the CPU 100, content of the communication data can be rewritten.

In other words, the various kinds of data such as the positional data and the detection data are processed as the display data in routes of paths P1, P2, and P4 illustrated in FIG. 1, or processed as the communication data in routes of paths P1, P2, P3, P5, and P6. Therefore, in the CPU 100, the content of various kinds of data such as the positional data and the detection data can be rewritten (falsified) by the application processor (APP) in the path P3.

By the way, in recent years, an application using positional data obtained by utilizing a GPS has been developed, and in this type of application, there is a problem that a game is advantageously proceeded by, for example, illegally acquiring an item or the like by transmitting faked positional data to the server 200 via the mobile communication network.

Here, security is provided in communication itself performed in the mobile communication network, and the communication data (transmission data) to the mobile communication network is managed by the application processor (APP). Therefore, for example, when the application processor (APP) is hacked or an unauthorized program is executed, there is no means to prevent transmission of the faked positional data.

More specifically, as illustrated in FIG. 1, content of the positional data passing through the path P3 can be rewritten (falsified) by the application processor (APP) in the CPU 100. Therefore, for example, when the CPU 100 is hacked and the content of the positional data is replaced, falsified positional data is transmitted as the communication data to the server 200.

Thus, in the communication device 10, there is a possibility that the positional data is falsified even when the positional data is encrypted and protected between respective LSIs because it is necessary to decrypt the encrypted positional data into plan text in the CPU 100 in order to display the positional information in accordance with the positional data on the touch panel unit 126. Accordingly, a technology to suppress such falsification of the positional data is demanded.

Furthermore, the positional data is described here, but not limited to the positional data, for example, the various kinds of data such as the detection data and the payment data may also be handled in a similar manner in the communication device 10.

The present technology is made in view of such situations and is directed to achieve suppression of falsification of data such as the positional data and the detection data processed as the communication data. Hereinafter, specific content of the present technology will be described referring to configurations of the first to ninth embodiments.

### 2. FIRST EMBODIMENT

FIG. 2 is a block diagram illustrating an exemplary configuration of a communication device according to a first embodiment.

In the first embodiment, a description will be provided for a configuration in a case where data to be protected in a communication device 10 is positional data from a GPS unit 120, and the positional data is transmitted as communication data (transmission data) to a server 200 of a base station via a mobile communication network.

In FIG. 2, in the communication device 10, a portion corresponding to a portion in a communication device 10 illustrated in FIG. 1 is denoted by the same reference sign and repetition of the same description will be omitted as appropriate.

In FIG. 2, a CPU 100 includes an application processor (APP) 101, and an analog baseband (ABB) 102, and a digital baseband (DBB) 103.

The application processor (APP) 101 includes a large scale integration (LSI) that performs processing of various kinds of applications.

The analog baseband (ABB) 102 is constituted as an analog baseband LSI, for example. The digital baseband (DBB) 103 is constituted as a digital baseband LSI, for example.

Here, in the communication device 10 of FIG. 2, positional data calculated by the GPS unit 120 is supplied to the CPU 100 and transferred as the communication data to a communication module unit 118, thereby transmitting the positional data to the server 200 via the mobile communication network.

At this time, the GPS unit 120 and the digital baseband (DBB) 103 exchange the positional data as the communication data via a hardware path. Therefore, the positional data is directly transferred from the GPS unit 120 to the digital baseband (DBB) 103 along a path P11, and is transmitted as the communication data to the communication module unit 118.

In other words, since the application processor (APP) 101 is excluded from the path P11 between the GPS unit 120 and the digital baseband (DBB) 103, the application processor (APP) 101 cannot refer to the positional data transferred as plain text PT11.

Accordingly, in the CPU 100, even when the positional data (plain text PT11) as the communication data is transferred, content of the positional data passing through the path P11 cannot be rewritten (falsified) by the application processor (APP) 101.

Note that here the hardware path used to deliver the positional data from the GPS unit 120 to the communication module unit 118 may be provided so that the positional data as the communication data can be transferred to the digital baseband (DBB) 103 from the GPS unit 120 along the path P11 and further transferred to the communication module unit 118.

Furthermore, in the communication device 10 of FIG. 2, the positional data calculated by the GPS unit 120 is supplied to the CPU 100 and processed as display data, thereby displaying positional information on (a screen of a display unit of) a touch panel unit 126.

At this time, since the positional data as the display data is transferred from the GPS unit 120 to the application processor (APP) 101 along a path P12, the application processor (APP) 101 processes the positional data transferred as plain text PT12 and displays the positional information on the touch panel unit 126.

Thus, there is a case where the positional data from the GPS unit 120 is not only transmitted to the server 200 via the mobile communication network but also displayed on the touch panel unit 126 in the communication device 10. The positional information can be easily displayed by separating the positional data into routes of: a communication data route along the path P11; and a display data route along the path P12.

The first embodiment has been described above. In the first embodiment, since the digital baseband (DBB) 103 and the GPS unit 120 exchange the positional data as the communication data via the hardware path (path P11), the application processor (APP) 101 is made unable to refer to the positional data.

As a result, the application processor (APP) 101 cannot rewrite (falsify) the content of the positional data (plain text PT11) passing through the path P11, and therefore, falsification of the positional data can be suppressed.

Note that, in FIG. 2, it is assumed that the communication performed between the communication module unit 118 of the communication device 10 and the server 200 of the base station via the mobile communication network is secure communication although not illustrated to simplify the description. Note that the fact that the communication via the mobile communication network is the secure communication is similarly applied to other embodiments described later.

### 3. SECOND EMBODIMENT

FIG. 3 is a block diagram illustrating an exemplary configuration of a communication device according to a second embodiment.

In the second embodiment, a description will be provided for a configuration in a case where data to be protected in a communication device 10 is positional data from a GPS unit 120, and the positional data is transmitted as communication data (transmission data) to a server 300 via a wireless LAN communication network.

In the communication device 10 of FIG. 3, a portion corresponding to a portion in a communication device 10 illustrated in FIG. 2 is denoted by the same reference sign and repetition of the same description will be omitted as appropriate.

Here, in the communication device 10 of FIG. 3, the positional data calculated by the GPS unit 120 is transferred as the communication data to a wireless communication unit 119, thereby transmitting the positional data to the server 300 (or an access point (AP)) via the wireless LAN communication network.

At this time, the GPS unit 120 and the wireless communication unit 119 exchange the positional data as the communication data via a hardware path. Therefore, the positional data is directly transferred from the GPS unit 120 to the wireless communication unit 119 along a path P21, and the positional data is packetized as one of application data by a CPU (not illustrated) inside the wireless communication unit 119, thereby performing wireless communication.

In other words, since an application processor (APP) 101 is excluded from the path 21 between the GPS unit 120 and the wireless communication unit 119, the application processor (APP) 101 cannot refer to the positional data transferred as plain text PT21.

Accordingly, even when the positional data (plain text PT21) as the communication data is transferred, content of the positional data passing through the path P21 cannot be rewritten (falsified) by the application processor (APP) 101.

Furthermore, in the communication device 10 of FIG. 3, the positional data calculated by the GPS unit 120 is supplied to a CPU 100 and processed as display data, thereby displaying positional information on (a screen of a display unit of) a touch panel unit 126.

At this time, since the positional data as the display data is transferred from the GPS unit 120 to the application processor (APP) 101 along a path P22, the application processor (APP) 101 processes the positional data transferred as plain text PT22 and displays the positional information on the touch panel unit 126.

Thus, there is a case where the positional data from the GPS unit 120 is not only transmitted to the server 300 via the wireless LAN communication network but also displayed on the touch panel unit 126 in the communication device 10. The positional data can be easily displayed by separating the positional data in routes of: a communication data route along the path P21; and a display data route along the path P22.

The second embodiment has been described above. In the second embodiment, since the wireless communication unit 119 and the GPS unit 120 exchange the positional data as the communication data via the hardware path (path P21), the application processor (APP) 101 is made unable to refer to the positional data.

As a result, the application processor (APP) 101 cannot rewrite (falsify) the content of the positional data (plain text PT21) passing through the path P21, and therefore, falsification of the positional data can be suppressed.

Note that, in FIG. 3, it is assumed that the communication performed between the wireless communication unit 119 of the communication device 10 and the server 300 (or access point) via the wireless LAN communication network is secure communication although not illustrated to simplify the description.

### 4. THIRD EMBODIMENT

FIG. 4 is a block diagram illustrating an exemplary configuration of a communication device according to a third embodiment.

In the third embodiment, a description will be provided for a configuration in a case where data to be protected in a communication device 10 is positional data from a GPS unit 120 and the positional data is transmitted as communication data (transmission data) to a server 200 of a base station via a mobile communication network and in a case where the positional data transferred inside the communication device 10 is encrypted.

In the communication device 10 of FIG. 4, a portion corresponding to a portion in a communication device 10 illustrated in FIG. 2 is denoted by the same reference sign and repetition of the same description will be omitted as appropriate.

Here, in the communication device 10 of FIG. 4, the positional data calculated by the GPS unit 120 is supplied to a CPU 100 and transferred as the communication data to a communication module unit 118, thereby transmitting the positional data to the server 200 via the mobile communication network.

At this time, the GPS unit 120 and the digital baseband (DBB) 103 exchange the positional data as the communication data via a hardware path. Therefore, the positional data is directly transferred from the GPS unit 120 to the digital baseband (DBB) 103 along a path P31.

Moreover, in FIG. 4, the positional data is encrypted by the GPS unit 120 by using an encryption key Ke31, and encrypted positional data obtained as a result thereof is supplied to a digital baseband (DBB) 103. In the digital baseband (DBB) 103, the encrypted positional data is decrypted by using a decryption key Kd31, and plain text PT31 of the positional data obtained as a result thereof is transmitted as the communication data to the communication module unit 118.

Note that an encryption method here is arbitrary, and various kinds of encryption methods can be adopted, and, for example, a common key cryptosystem, a public key cryptosystem, or the like can be adopted. In other words, in a case of adopting the common key cryptosystem, the same key is used for the encryption key Ke31 and the decryption key Kd31. Furthermore, in a case of adopting the public key cryptosystem, a public key and a secret key are used as the encryption key Ke31 and the decryption key Kd31. Note that the fact that the encryption method is arbitrary is similarly applied to other embodiments described later.

In other words, since an application processor (APP) 101 is excluded from the path P31 between the GPS unit 120 and the digital baseband (DBB) 103 and the positional data is further encrypted, the application processor (APP) 101 cannot refer to the transferred encrypted positional data.

Accordingly, in the CPU 100, even when the encrypted positional data as the communication data is transferred, content of the encrypted positional data passing through the path P31 cannot be rewritten (falsified) by the application processor (APP) 101.

Furthermore, in the communication device 10 of FIG. 4, the positional data calculated by the GPS unit 120 is supplied to the CPU 100 and processed as display data, thereby displaying positional information on (a screen of a display unit of) a touch panel unit 126. However, encryption processing is not applied to the positional data processed as the display data.

At this time, since the positional data as the display data is transferred from the GPS unit 120 to the application processor (APP) 101 along a path P32, the application processor (APP) 101 processes the positional data transferred as plain text PT32 and displays the positional information on the touch panel unit 126.

Thus, there is a case where the positional data from the GPS unit 120 is not only transmitted to the server 200 via the mobile communication network but also displayed on the touch panel unit 126 in the communication device 10. The positional data can be easily displayed by separating the positional data into routes of: a communication data route along the path P31; and a display data route along the path P32.

The third embodiment has been described above. In the third embodiment, since the digital baseband (DBB) 103 and the GPS unit 120 exchange the positional data as the communication data via the hardware path (path P31) and the positional data is further encrypted, the application processor (APP) 101 is made unable to refer to the positional data.

As a result, the application processor (APP) 101 cannot rewrite (falsify) the content of the encrypted positional data passing through the path P31, and therefore, falsification of the positional data can be suppressed.

### 5. FOURTH EMBODIMENT

FIG. 5 is a block diagram illustrating an exemplary configuration of a communication device according to a fourth embodiment.

In the fourth embodiment, a description will be provided for a configuration in a case where data to be protected in a communication device 10 is positional data from a GPS unit 120, and the positional data is transmitted as communication data (transmission data) to a server 200 of a base station via a mobile communication network and in a case where the positional data having passed through the mobile communication network is encrypted.

In the communication device 10 of FIG. 5, a portion corresponding to a portion in a communication device 10 illustrated in FIG. 2 is denoted by the same reference sign and repetition of the same description will be omitted as appropriate.

Here, in the communication device 10 of FIG. 5, the positional data calculated by the GPS unit 120 is supplied to a CPU 100 and transferred as the communication data to a communication module unit 118, thereby transmitting the positional data to the server 200 via the mobile communication network.

At this time, the GPS unit 120 and the digital baseband (DBB) 103 exchange the positional data as the communication data via a hardware path. Therefore, the positional data is directly transferred from the GPS unit 120 to the digital baseband (DBB) 103 along a path P41.

Moreover, in FIG. 5, the positional data is encrypted by the GPS unit 120 by using an encryption key Ke41, and encrypted positional data obtained as a result thereof is supplied to the digital baseband (DBB) 103 and transmitted as the communication data to the communication module unit 118. Then, the encrypted positional data as the communication data is transmitted to the server 200 by the communication module unit 118 via the mobile communication network.

On the other hand, in the base station, the encrypted positional data transmitted from the communication device 10 is received in the server 200 via the mobile communication network. In the server 200, the encrypted positional data is decrypted by using a decryption key Kd41, and plain text PT41 of the positional data obtained as a result thereof is processed.

In other words, since an application processor (APP) 101 is excluded from the path P41 between the GPS unit 120 and the digital baseband (DBB) 103 and the positional data is further encrypted, the application processor (APP) 101 cannot refer to the transferred encrypted positional data.

Accordingly, in the CPU 100, even when the encrypted positional data as the communication data is transferred, content of the encrypted positional data passing through the path P41 cannot be rewritten (falsified) by the application processor (APP) 101.

Furthermore, in the communication device 10 of FIG. 5, the positional data calculated by the GPS unit 120 is supplied to the CPU 100 and processed as display data, thereby displaying positional information on (a screen of a display unit of) a touch panel unit 126. However, encryption processing is not applied to the positional data processed as the display data.

At this time, since the positional data as the display data is transferred from the GPS unit 120 to the application processor (APP) 101 along a path P42, the application processor (APP) 101 processes the positional data transferred as plain text PT42 and displays the positional information on the touch panel unit 126.

Thus, there is a case where the positional data from the GPS unit 120 is not only transmitted to the server 200 via the mobile communication network but also displayed on the touch panel unit 126 in the communication device 10. The positional data can be easily displayed by separating the positional data into routes of: a communication data route along the path P41; and a display data route along the path P42.

The fourth embodiment has been described above. In the fourth embodiment, since the digital baseband (DBB) 103 and the GPS unit 120 exchange the positional data as the communication data via the hardware path (path P41) and the positional data is further encrypted, the application processor (APP) 101 is made unable to refer to the positional data.

As a result, the application processor (APP) 101 cannot rewrite (falsify) the content of the encrypted positional data passing through the path P41, and therefore, falsification of the positional data can be suppressed.

### 6. FIFTH EMBODIMENT

FIG. 6 is a block diagram illustrating an exemplary configuration of a communication device according to a fifth embodiment.

In the fifth embodiment, a description will be provided for a configuration in a case where data to be protected in a communication device 10 is positional data from a GPS unit 120 and the positional data is transmitted as communication data (transmission data) to a server 200 of a base station via a mobile communication network and in a case where the positional data transferred inside the communication device 10 is encrypted.

In the communication device 10 of FIG. 6, a portion corresponding to a portion in a communication device 10 illustrated in FIG. 2 is denoted by the same reference sign and repetition of the same description will be omitted as appropriate.

Furthermore, the communication device 10 in FIG. 6 is common with a communication device in FIG. 4 in that: the GPS unit 120 and a digital baseband (DBB) 103 exchange the positional data as the communication data; and the positional data therebetween is encrypted.

On the other hand, in the communication device 10 in FIG. 6 differs from the communication device in FIG. 4 in that the positional data exchanged between the GPS unit 120 and the digital baseband (DBB) 103 is exchanged via an application processor (APP) 101.

In other words, in FIG. 6, the positional data is encrypted by the GPS unit 120 by using an encryption key Ke51, and encrypted positional data obtained as a result thereof is supplied to the digital baseband (DBB) 103 via the application processor (APP) 101. In the digital baseband (DBB) 103, the encrypted positional data is decrypted by using a decryption key Kd51, and plain text PT51 of the positional data obtained as a result thereof is transmitted as the communication data to a communication module unit 118.

That is, a path P51 between the GPS unit 120 and the digital baseband (DBB) 103 passes through the application processor (APP) 101, but since the positional data is encrypted, the application processor (APP) 101 cannot refer to the transferred encrypted positional data.

Accordingly, in a CPU 100, even when the encrypted positional data as the communication data is transferred, content of the encrypted positional data passing through the path P51 cannot be rewritten (falsified) by the application processor (APP) 101. Furthermore, the path P51 and the path P52 are the same path partway, and data is output from the same exit of the GPS unit 120 and received from the same entrance of the application processor (APP) 101. So to speak, in the path of this portion, both of the encrypted positional data as the communication data and the positional data (plain text) as display data flow on the same path.

The fifth embodiment has been described above. In the fifth embodiment, since the digital baseband (DBB) 103 and the GPS unit 120 exchange the encrypted positional data, the application processor (APP) 101 is made unable to refer to the positional data.

As a result, the application processor (APP) 101 cannot rewrite (falsify) the content of the encrypted positional data passing through the path P51, and therefore, falsification of the positional data can be suppressed. Furthermore, in the fifth embodiment, it is possible to provide a unified path between the GPS unit 120 and the application processor (APP) 101 while suppressing falsification of the positional data.

### 7. SIXTH EMBODIMENT

FIG. 7 is a block diagram illustrating an exemplary configuration of a communication device according to a sixth embodiment.

In the sixth embodiment, a configuration in a case where data to be protected by a communication device 10 is payment data transmitted from a server 200 of a base station via a mobile communication network and in a case where the payment data as communication data (reception data) is transferred to a payment support wireless communication unit 121 in the communication device 10 will be described.

In the communication device 10 of FIG. 7, a portion corresponding to a portion in a communication device 10 illustrated in FIG. 2 is denoted by the same reference sign and repetition of the same description will be omitted as appropriate.

Here, in the communication device 10 of FIG. 7, payment data processed by the server 200 of the base station is transmitted as the communication data via the mobile communication network and received by a communication module unit 118 of the communication device 10. The payment data as the communication data is transferred along a path 61 from the communication module unit 118 to the payment support wireless communication unit 121 via a digital baseband (DBB) 103 of a CPU 100.

At this time, the digital baseband (DBB) 103 and the payment support wireless communication unit 121 exchange the payment data as the communication data via a hardware path. Therefore, the payment data is directly transferred from the digital baseband (DBB) 103 to the payment support wireless communication unit 121 along the path P61, and the payment support wireless communication unit 121 performs processing associated with electronic payment on the basis of the payment data (e.g., processing to charge a predetermined amount of money, and the like).

In other words, since an application processor (APP) 101 is excluded from the path P61 between the digital baseband (DBB) 103 and the payment support wireless communication unit 121, the application processor (APP) 101 cannot refer to the payment data transferred as plain text PT61.

Accordingly, in the CPU 100, even when the payment data (plain text PT61) as the communication data is transferred, content of the payment data passing through the path P61 cannot be rewritten (falsified) by the application processor (APP) 101.

Furthermore, in the communication device 10 of FIG. 7, the payment data received by the communication module unit 118 is supplied to the CPU 100 and processed as display data, thereby displaying payment information (e.g., information of the predetermined amount of money to be charged, or the like) on (a screen of a display unit of) a touch panel unit 126.

At this time, since the payment data as the display data is transferred from the digital baseband (DBB) 103 to the application processor (APP) 101 along a path P62, the application processor (APP) 101 processes the payment data transferred as plain text PT62 and displays the payment information on the touch panel unit 126.

Thus, there is a case where the payment data transmitted from the server 200 is not only processed by the payment support wireless communication unit 121 but also displayed on the touch panel unit 126 in the communication device 10. The payment information can be easily displayed by separating the payment data into routes of: a communication data route along the path P61; and a display data route along the path P62.

The sixth embodiment has been described above. In the sixth embodiment, since the digital baseband (DBB) 103 and the payment support wireless communication unit 121 exchange the payment data as the communication data via the hardware path (path P61), the application processor (APP) 101 is made unable to refer to the payment data.

As a result, the application processor (APP) 101 cannot rewrite (falsify) the content of the payment data (plain text PT61) passing through the path P61, and therefore, falsification of the payment data can be suppressed.

### 8. SEVENTH EMBODIMENT

FIG. 8 is a block diagram illustrating an exemplary configuration of a communication device according to a seventh embodiment.

In the seventh embodiment, a description will be provided for a configuration in a case where data to be protected by a communication device 10 is payment data transmitted from a server 200 of a base station via a mobile communication network and in a case where the payment data as communication data (reception data) is encrypted and then transferred to a payment support wireless communication unit 121 in the communication device 10.

In the communication device 10 of FIG. 8, a portion corresponding to a portion in a communication device 10 illustrated in FIG. 2 is denoted by the same reference sign and repetition of the same description will be omitted as appropriate.

Here, in the communication device 10 of FIG. 8, payment data processed by the server 200 of the base station is transmitted as the communication data via the mobile communication network and received by a communication module unit 118 of the communication device 10. The payment data as the communication data is directly transferred from a digital baseband (DBB) 103 to the payment support wireless communication unit 121 via a hardware path along a path P71.

Moreover, in FIG. 8, the payment data is encrypted by using an encryption key Ke71 by the digital baseband (DBB) 103, and encrypted payment data obtained as a result thereof is supplied to the payment support wireless communication unit 121. In the payment support wireless communication unit 121, the encrypted payment data is decrypted by using a decryption key Kd71 and applies, to plain text PT71 of payment data as a result thereof, processing associated with electronic payment (e.g., processing to charge a predetermined amount of money, and the like).

In other words, since an application processor (APP) 101 is excluded from the path P71 between the digital baseband (DBB) 103 and the payment support wireless communication unit 121 and the payment data is further encrypted, the application processor (APP) 101 cannot refer to the transferred encrypted payment data.

Accordingly, in a CPU 100, even when the encrypted payment data as the communication data is transferred, content of the encrypted payment data passing through the path P71 cannot be rewritten (falsified) by the application processor (APP) 101.

Furthermore, in the communication device 10 of FIG. 8, the payment data received by the communication module unit 118 is supplied to the CPU 100 and processed as display data, thereby displaying payment information (e.g., information of the predetermined amount of money to be charged, or the like) on (a screen of a display unit of) a touch panel unit 126. However, encryption processing is not applied to the payment data processed as the display data.

At this time, since the payment data as the display data is transferred from the digital baseband (DBB) 103 to the application processor (APP) 101 along a path P72, the application processor (APP) 101 processes the payment data transferred as plain text PT72 and displays the payment information on the touch panel unit 126.

Thus, there is a case where the payment data transmitted from the server 200 is not only processed by the payment support wireless communication unit 121 but also displayed on the touch panel unit 126 in the communication device 10, however, the detection information can be easily displayed by separating the payment data into routes of: a communication data route along the path P71 and a display data route along the path P72.

The seventh embodiment has been described above. In the seventh embodiment, since the digital baseband (DBB) 103 and the payment support wireless communication unit 121 exchange the payment data as the communication data via the hardware path (path P71), the application processor (APP) 101 is made unable to refer to the payment data.

As a result, the application processor (APP) 101 cannot rewrite (falsify) the content of the payment data (plain text PT71) passing through the path P71, and therefore, falsification of the payment data can be suppressed.

### 9. EIGHTH EMBODIMENT

FIG. 9 is a block diagram illustrating an exemplary configuration of a communication device according to an eighth embodiment.

In the eighth embodiment, a description will be provided for a configuration in a case where data to be protected in a communication device 10 is detection data from a sensor unit 122, and the detection data is transmitted as communication data (transmission data) to a server 200 of a base station via a mobile communication network.

In the communication device 10 of FIG. 9, a portion corresponding to a portion in a communication device 10 illustrated in FIG. 2 is denoted by the same reference sign and repetition of the same description will be omitted as appropriate.

Here, in the communication device 10 of FIG. 9, the detection data detected by the sensor unit 122 is supplied to a CPU 100 and transferred as the communication data to a communication module unit 118, thereby transmitting the detection data to the server 200 via the mobile communication network.

At this time, the sensor unit 122 and a digital baseband (DBB) 103 exchange the detection data as the communication data via a hardware path. Therefore, the detection data is directly transferred from the sensor unit 122 to the digital baseband (DBB) 103 along a path P81, and is transmitted as the communication data to the communication module unit 118.

In other words, since the application processor (APP) 101 is excluded from the path P81 between the sensor unit 122 and the digital baseband (DBB) 103, the application processor (APP) 101 cannot refer to the detection data transferred as plain text PT81.

Accordingly, in the CPU 100, even when the detection data (plain text PT81) as the communication data is transferred, content of the detection data passing through the path P81 cannot be rewritten (falsified) by the application processor (APP) 101.

Furthermore, in the communication device 10 of FIG. 9, the detection data detected by the sensor unit 122 is supplied to the CPU 100 and processed as display data, thereby displaying detection information (e.g., biological information or the like) on (a screen of a display unit of) a touch panel unit 126.

At this time, since the detection data as the display data is transferred from the sensor unit 122 to the application processor (APP) 101 along a path P82, the application processor (APP) 101 processes the detection data transferred as plain text PT82 and displays the detection information on the touch panel unit 126.

Thus, there is a case where the detection data from the sensor unit 122 is not only transmitted to the server 200 via the mobile communication network but also displayed on the touch panel unit 126 in the communication device 10, however, the detection information can be easily displayed by separating the detection data into routes of: a communication data route along the path P81; and a display data route along the path P82.

The eighth embodiment has been described above. In the eighth embodiment, since the digital baseband (DBB) 103 and the sensor unit 122 exchange the detection data as the communication data via the hardware path (path P81), the application processor (APP) 101 is made unable to refer to the detection data.

As a result, the application processor (APP) 101 cannot rewrite (falsify) the content of the detection data (plain text PT81) passing through the path P81, and therefore, falsification of the detection data can be suppressed.

### 10. NINTH EMBODIMENT

FIG. 10 is a block diagram illustrating an exemplary configuration of a communication device according to a ninth embodiment.

In the ninth embodiment, a description will be provided for a configuration in a case where data to be protected in a communication device 10 is detection data from a sensor unit 122 and the detection data is transmitted as communication data (transmission data) to a server 200 of a base station via a mobile communication network and in a case where the detection data transferred inside the communication device 10 is encrypted.

In the communication device 10 of FIG. 10, a portion corresponding to a portion in a communication device 10 illustrated in FIG. 2 is denoted by the same reference sign and repetition of the same description will be omitted as appropriate.

Here, in the communication device 10 of FIG. 10, the detection data detected by the sensor unit 122 is supplied to a CPU 100 and transferred as the communication data to a communication module unit 118, thereby transmitting the detection data to the server 200 via the mobile communication network.

At this time, the sensor unit 122 and a digital baseband (DBB) 103 exchange the detection data as the communication data via a hardware path. Therefore, the detection data is directly transferred from the sensor unit 122 to the digital baseband (DBB) 103 along a path P91.

Furthermore, in FIG. 10, the detection data is encrypted by the sensor unit 122 by using an encryption key Ke91, and encrypted detection data obtained as a result thereof is supplied to a digital baseband (DBB) 103. In the digital baseband (DBB) 103, the encrypted detection data is decrypted by using a decryption key Kd91, and plain text PT91 of the detection data obtained as a result thereof is transmitted as communication data to a communication module unit 118.

In other words, since an application processor (APP) 101 is excluded from the path P91 between the sensor unit 122 and the digital baseband (DBB) 103 and the detection data is further encrypted, the application processor (APP) 101 cannot refer to the transferred encrypted detection data.

Accordingly, in a CPU 100, even when the encrypted detection data as the communication data is transferred, content of the encrypted detection data passing through the path P91 cannot be rewritten (falsified) by the application processor (APP) 101.

Furthermore, in the communication device 10 of FIG. 10, the detection data detected by the sensor unit 122 is supplied to the CPU 100 and processed as display data, thereby displaying detection information (e.g., biological information or the like) on (a screen of a display unit of) a touch panel unit 126. However, encryption processing is not applied to the detection data processed as the display data.

At this time, since the detection data as the display data is transferred from the sensor unit 122 to the application processor (APP) 101 along a path P92, the application processor (APP) 101 processes the detection data transferred as plain text PT92 and displays the detection information on the touch panel unit 126.

Thus, there is a case where the detection data from the sensor unit 122 is not only transmitted to the server 200 via the mobile communication network but also displayed on the touch panel unit 126 in the communication device 10, however, the detection information can be easily displayed by separating the detection data into routes of: a communication data route along the path P91; and a display data route along the path P92.

The ninth embodiment has been described above. In the ninth embodiment, since the digital baseband (DBB) 103 and the sensor unit 122 exchange the detection data as the communication data via the hardware path (path P91) and the detection data is encrypted, the application processor (APP) 101 is made unable to refer to the detection data.

As a result, the application processor (APP) 101 cannot rewrite (falsify) the content of the encrypted detection data passing through the path P91, and therefore, falsification of the detection data can be suppressed.

As described above, according to the present technology, it is possible to suppress falsification of various kinds of data such as the positional data, the payment data, and the detection data which are processed as the communication data.

Furthermore, for example, correct communication data (transmission data) can be transmitted to the server via the communication network without being falsified by software while the communication data (transmission data), such as the positional data calculated by the GPS unit 120 and the positional data detected by the sensor unit 122, is processed as the display data corresponding to the communication data and displayed on (the screen of the display unit of) the touch panel unit 126 of the communication device 10.

Furthermore, for example, correct communication data (reception data) can be transferred to an LSI, a memory unit, or the like inside the communication device 10 without being falsified by the software while the communication data (reception data) from the server is received via the communication network, processed as the display data, and displayed on (the screen of the display unit of) the touch panel unit 126 of the communication device 10.

For example, as described above, according to the present technology, transmission of faked positional data can be prevented in advance because the application processor (APP) is made unable to refer to the positional data although, conventionally, there is no means to prevent transmission of such faked positional data when the application processor (APP) is hacked or when an unauthorized program is executed at the time of executing an application that uses positional data obtained by utilizing the GPS.

### 11. MODIFIED EXAMPLES

In the above description, the description has been provided by exemplifying, as the communication data, the positional data processed by the GPS unit 120, the payment data processed by the payment support wireless communication unit 121, and the detection data processed by the sensor unit 122, but various kinds of data supplied from the respective units (data processing units) connected to the CPU 100 can be set as the communication data.

For example, various kinds of data such as recording data recorded in the memory card unit 115, audio data processed by the audio signal processing unit 123, and imaging data processed by the camera image processing unit 127 can be set as the communication data. Furthermore, the recording data, the audio data, and the imaging data can be processed as display data, and display information thereof can be displayed.

Furthermore, the first to ninth embodiments described above are examples of specific content of the present technology, and needless to mention that not only each of the embodiments is established as an independent embodiment but also an embodiment combining all or part of the plurality of embodiments to the possible extent may also be adopted.

For example, the payment data exchanged between the digital baseband (DBB) 103 and the payment support wireless communication unit 121 may be exchanged via the application processor (APP) 101 by combining the fifth embodiment illustrated in FIG. 6 with the seventh embodiment illustrated in FIG. 8. In this case, the path P71 between the digital baseband (DBB) 103 and the payment support wireless communication unit 121 passes through the application processor (APP) 101, but the payment data is encrypted, and therefore, the application processor (APP) 101 cannot refer to the transferred encrypted payment data.

Similarly, for example, the detection data exchanged between the sensor unit 122 and the digital baseband (DBB) 103 may be exchanged via the application processor (APP) 101 by combining the fifth embodiment illustrated in FIG. 6 with the ninth embodiment illustrated in FIG. 10. In this case, the path P91 between the sensor unit 122 and the digital baseband (DBB) 103 passes through the application processor (APP) 101, but the detection data is encrypted, and therefore, the application processor (APP) 101 cannot refer to the transferred encrypted detection data.

Furthermore, by combination of the sixth embodiment or the seventh embodiment illustrated in FIG. 7 or FIG. 8 with the embodiments of the first to fifth embodiments illustrated in FIGS. 2 to 6, the positional data as the communication data may be processed as the reception data not as the transmission data. Moreover, by combination of the sixth embodiment or the seventh embodiment illustrated in FIG. 7 or FIG. 8 with the eighth embodiment or the ninth embodiment illustrated in FIG. 9 or FIG. 10, the detection data as the communication data may be processed as the reception data not as the transmission data.

In the above description, it has been described that the display data is processed by the application processor (APP) 101, but not limited to the display data, it is sufficient if corresponding data that corresponds to the communication data is processed by the application processor (APP) 101. Furthermore, in the above description, it has been described that the application processor (APP) 101, the analog baseband (ABB) 102, and the digital baseband (DBB) 103 integrally constitute the CPU 100, but the analog baseband (ABB) 102 and the digital baseband (DBB) 103 may be constituted as a different circuit.

Furthermore, in the above description, it has been described that the application processor (APP) 101 is made unable to refer to the communication data by providing a hardware path and applying encryption processing to the communication data, but this can also be regarded that control is performed in the communication device 10 so that the application processor (APP) 101 is made unable to refer to the communication data.

Note that the embodiments of the present technology are not limited to the above-described embodiments, and various kinds of modifications can be made within a scope without departing from the gist of the present technology. For example, the present technology can adopt a cloud computing configuration in which a plurality of devices shares one function via a network and performs processing in a collaborative manner.

Furthermore, the present technology can adopt following configurations.

(1)

A communication device including:

an application processing unit configured to perform application processing;

a communication unit configured to perform data communication; and

a data processing unit configured to exchange, with the communication unit, communication data to be a communication object,

in which the application processing unit is made unable to refer to the communication data.

(2)

The communication device recited in (1) above,

in which the communication unit and the data processing unit exchange the communication data via a hardware path in which the application processing unit is excluded.

(3)

The communication device recited in (1) above, in which the communication unit and the data processing unit exchange the communication data encrypted so as to disable decryption at the application processing unit.

(4)

The communication device recited in (3) above,

in which the communication data is exchanged via a hardware path in which the application processing unit is excluded.

(5)

The communication device recited in (3) above,

in which the communication data is exchanged via the application processing unit.

(6)

The communication device recited in any one of (1) to (5) above,

in which the application processing unit processes corresponding data that corresponds to the communication data.

(7)

The communication device recited in (6) above, further including

a display unit,

in which the corresponding data includes display data to be displayed on the display unit.

(8)

The communication device recited in any one of (1) to (7) above,

in which the application processing unit is included in a processor connected to one or a plurality of the data processing units.

(9)

The communication device recited in (8) above,

in which the processor further includes a baseband processing unit configured to process the communication data, and

the baseband processing unit transfers the communication data exchanged between the communication unit and the data processing unit.

(10)

The communication device recited in (9) above,

in which the baseband processing unit and the data processing unit exchange the communication data via a hardware path in which the application processing unit is excluded.

(11)

The communication device recited in (9) above,

in which the baseband processing unit and the data processing unit exchange the communication data encrypted so as to disable decryption at the application processing unit.

(12)

The communication device recited in (11) above,

in which the communication data exchanged between the baseband processing unit and the data processing unit is encrypted,

the baseband processing unit encrypts or decrypts the communication data, and

the data processing unit decrypts or encrypts the communication data.

(13)

The communication device recited in (11) above,

in which the communication data exchanged between a data processing unit and a processing device configured to process the communication data is encrypted,

the processing device encrypts or decrypts the communication data, and

the data processing unit decrypts or encrypts the communication data.

(14)

The communication device recited in any one of (1) to (13) above,

in which the communication data includes transmission data to be transmitted to a processing device configured to process the communication data.

(15)

The communication device recited in any one of (1) to (13) above,

in which the communication data includes reception data to be received from a processing device configured to process the communication data.

(16)

The communication device recited in any one of (1) to (15) above,

in which the data processing unit includes a positional information processing unit, and

the communication data includes positional data calculated by the positional information processing unit.

(17)

The communication device recited in any one of (1) to (15) above,

in which the data processing unit includes a sensor unit, and

the communication data includes detection data detected by the sensor unit.

(18)

The communication device recited in any one of (1) to (15) above,

in which the data processing unit includes an electronic payment processing unit, and

the communication data includes payment data processed by the electronic payment processing unit.

(19)

The communication device recited in any one of (9) to (13) above,

in which the processor includes a central processing unit (CPU),

the application processing unit includes an application processor (APP), and

the baseband processing unit includes an analog baseband (ABB) and a digital baseband (DBB).

(20)

A control method for a communication device including: an application processing unit configured to perform application processing;

a communication unit configured to perform data communication; and

a data processing unit configured to exchange, with the communication unit, communication data to be a communication object,

the control method including:

a step of performing control, by the communication device, so as to make the application processing unit unable to refer to the communication data.

### REFERENCE SIGNS LIST

Communication device
100 CPU
101 Application processor (APP)
102 Analog baseband (ABB)
103 Digital baseband (DBB)
111 Flash memory unit
112 DRAM
113 SIM card unit
114 Input unit
115 Memory card unit
116 Antenna unit
117 Amplifier unit
118 Communication module unit
119 Wireless communication unit
120 GPS unit
121 Near field wireless communication unit
122 Sensor unit
123 Audio signal processing unit
124 Audio input/output unit
125 Controller unit
126 Touch panel unit
127 Camera image processing unit
128 Camera unit
129 Power supply control unit
130 Battery unit
200 Server
300 Server

1. A communication device comprising:
an application processing unit configured to perform application processing;
a communication unit configured to perform data communication; and
a data processing unit configured to exchange, with the communication unit, communication data to be a communication object,
wherein the application processing unit is made unable to refer to the communication data.

2. The communication device according to claim 1,
wherein the communication unit and the data processing unit exchange the communication data via a hardware path in which the application processing unit is excluded.

3. The communication device according to claim 1,
wherein the communication unit and the data processing unit exchange the communication data encrypted so as to disable decryption at the application processing unit.

4. The communication device according to claim 3,
wherein the communication data is exchanged via a hardware path in which the application processing unit is excluded.

5. The communication device according to claim 3,
wherein the communication data is exchanged via the application processing unit.

6. The communication device according to claim 1,
wherein the application processing unit processes corresponding data that corresponds to the communication data.

7. The communication device according to claim 6, further comprising
a display unit,
wherein the corresponding data includes display data to be displayed on the display unit.

8. The communication device according to claim 1,
wherein the application processing unit is included in a processor connected to one or a plurality of the data processing units.

9. The communication device according to claim 8,
wherein the processor further includes a baseband processing unit configured to process the communication data, and
the baseband processing unit transfers the communication data exchanged between the communication unit and the data processing unit.

10. The communication device according to claim 9,
wherein the baseband processing unit and the data processing unit exchange the communication data via a hardware path in which the application processing unit is excluded.

11. The communication device according to claim 9,
wherein the baseband processing unit and the data processing unit exchange the communication data encrypted so as to disable decryption at the application processing unit.

12. The communication device according to claim 11,
wherein the communication data exchanged between the baseband processing unit and the data processing unit is encrypted,
the baseband processing unit encrypts or decrypts the communication data, and
the data processing unit decrypts or encrypts the communication data.

13. The communication device according to claim 11,
wherein the communication data exchanged between the data processing unit and a processing device configured to process the communication data is encrypted,
the processing device encrypts or decrypts the communication data, and
the data processing unit decrypts or encrypts the communication data.

14. The communication device according to claim 1,
wherein the communication data includes transmission data to be transmitted to a processing device configured to process the communication data.

15. The communication device according to claim 1,
wherein the communication data includes reception data to be received from a processing device configured to process the communication data.

16. The communication device according to claim 8,
wherein the data processing unit includes a positional information processing unit, and
the communication data includes positional data calculated by the positional information processing unit.

17. The communication device according to claim 8,
wherein the data processing unit includes a sensor unit, and
the communication data includes detection data detected by the sensor unit.

18. The communication device according to claim 8,
wherein the data processing unit includes an electronic payment processing unit, and
the communication data includes payment data processed by the electronic payment processing unit.

19. The communication device according to claim 9,
wherein the processor includes a central processing unit (CPU),
the application processing unit includes an application processor (APP), and
the baseband processing unit includes an analog baseband (ABB) and a digital baseband (DBB).

20. A control method for a communication device including:
an application processing unit configured to perform application processing;
a communication unit configured to perform data communication; and
a data processing unit configured to exchange, with the communication unit, communication data to be a communication object,
the control method comprising:
a step of performing control, by the communication device, so as to make the application processing unit unable to refer to the communication data.
